(19) United States
(12) Patent Application Publication
(10) Pub. No.: US 2018/0246959 A1
(43) Pub. Date: Aug. 30, 2018

(54) ISA: A FAST SCALABLE AND ACCURATE ALGORITHM FOR SUPERVISED OPINION ANALYSIS

(71) Applicants: Stefano Maria Iacus, Milano (IT); Andrea Ceron, Busto Arsizio (IT); Luigi Curini, Milano (IT)

(72) Inventors: Stefano Maria Iacus, Milano (IT); Andrea Ceron, Busto Arsizio (IT); Luigi Curini, Milano (IT)

(21) Appl. No.: 15/758,539

(22) PCT Filed: Sep. 5, 2016
(86) PCT No.: PCT/IB2016/001268

§ 371 Date: Mar. 8, 2018

Related U.S. Application Data
(60) Provisional application No. 62/215,264, filed on Sep. 8, 2015.

(51) Int. Cl. G06F 17/30; G06F 17/27; H04L 12/58

(52) U.S. Cl. CPC G06F 17/30707; H04L 51/04; G06F 17/2785

(57) ABSTRACT

We present iSA (integrated Sentiment Analysis), a novel algorithm designed for social networks and Web 2.0 sphere (Twitter, blogs, etc.) opinion analysis. Instead of working on individual classification and then aggregating the estimates, iSA estimates directly the aggregated distribution of opinions. Not being based on NLP techniques or ontological dictionaries but on supervised hand-coding, iSA is a language agnostic algorithm (up to human coders' ability). iSA exploits a dimensionality reduction approach which makes it scalable, fast, memory efficient, stable and statistically accurate. Cross-tabulation of opinions is possible with iSA thanks to its stability. It will be shown when iSA outperforms machine learning techniques of individual classification (e.g. SVM, Random Forests, etc.) as well as the only other alternative for aggregated sentiment analysis like ReadMe.

### CROSS-REFERENCE TO RELATED APPLICATION

This application claims priority to United State Provisional Patent Application No. 62/215264 entitled ISA: A FAST, SCALABLE AND ACCURATE ALGORITHM FOR SUPERVISED OPINION ANALYSIS filed on 2015-09-08.

### FIELD OF THE INVENTION

This invention relates to the field of data classification systems. More precisely, it relates to a method for estimating the distribution of semantic content in digital messages in the presence of noise, taking as input data from a source of unstructured, structured, or only partially structured source data and outputting a distribution of semantic categories with associated frequencies.

### BACKGROUND OF THE INVENTION

The diffusion of Internet and the striking growth of social media, such as Facebook and Twitter, certainly represent one of the primary sources of the so called Big Data Revolution that we are experiencing nowadays. As millions of citizens start to surf the web, create their own account profiles and share information on-line, a wide amount of data becomes available. Such data can then be exploited in order to explain and anticipate dynamics on different topics such as stock markets, movie success, disease outbreaks, elections, etc., yielding potentially relevant consequences on the real world. Still the debate remains open with respect to the method that should be used to extract such information. Recognizing the relatively low informative value of merely counting the number of mentions, likes, followers and so on, the literature has largely focused on different types of sentiment analysis and opinion mining techniques (Cambria, E., Schuller, B., Xia, Y., Havasi, C., 2013. New avenues in opinion mining and sentiment analysis. IEEE Intelligent Systems 28 (2), 15-21.).

The state of the art in the field of supervised sentiment analysis is represented by the approach called ReadMe (Hopkins, D., King, G., 2010. A method of automated nonparametric content analysis for social science. American Journal of Political Science 54 (1), 229-247.). The reason of this performance is that, while most statistical models or text mining techniques are designed to work on corpus of texts from a given and well defined population, i.e. without misspecification, in reality texts coming from Twitter or other social networks are usually dominated by noise, no matter how accurate is the data crawling. Typical machine learning algorithms based on individual classification, are affected by the noise dominance. The idea of Hopkins and King (2010) was to attempt direct estimation of the distribution of the opinions instead of performing individual classification leading to accurate estimates. The method is disclosed in U.S. Pat. No. 8,180,717 B2.

### SUMMARY OF THE INVENTION

Here we present a novel, fast, scalable and accurate innovation to the original Hopkins and King (2010) sentiment analysis algorithm which we call: iSA (integrated Sentiment Analysis).

iSA improves over traditional approaches in that it is more efficient in terms of memory usage, execution times, lower bias and higher accuracy of estimation. Contrary to, e.g., the Random Forest (Breiman, L., 2001. Random forests. Machine Learning 45 (1), 5-32.) or the ReadMe (Hopkins and King, 2010) methods, iSA is an exact method not based on a simulation or resampling and it allows for the estimation of the distribution of opinions even when the number of them is very large. Due to its stability, it also allows for crosstabulation analysis when each text is classified according to two or more dimensions.

### BRIEF DESCRIPTION OF THE DRAWINGS

In the drawings:

FIG. 1 The space S̅×D. Visual explanation of why, when the noise D₀ category is dominant in the data, the estimation of P(S|D) is reasonably more accurate than the estimation of counterpart P(D|S);

FIG. 2 The iSA workflow and innovation;

FIG. 3 Preliminary Data cleaning and the preparation of the Document-Term matrix for the corpus of digital texts;

FIG. 4 The workflow form data tagging to aggregated distribution estimation of dimension D via iSA algorithm; and

FIG. 5 How to produce cross-tabulation using a one-dimensional algorithm Isa, optional step.

### DETAILED DESCRIPTION

Assume we have a corpus of N texts. Let us denote by

D={D₀, D₁, D₂, . . . D_{M}} the set of M+1 possible categories, i.e. sentiments or opinions expressed in the texts, and let us denote by D₀ the category dominant in the data which absorbs most of the probability mass of ({(D),D∈D}: the distribution of opinions in the corpus. Remark that P(D) is the primary target of estimation in the content of social sciences.

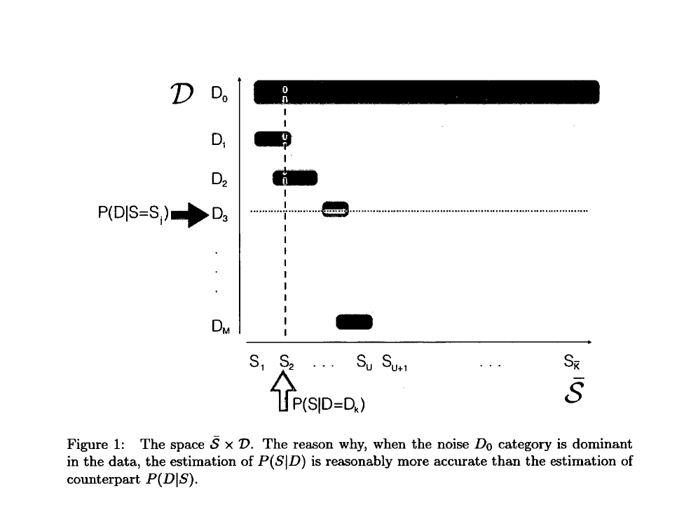

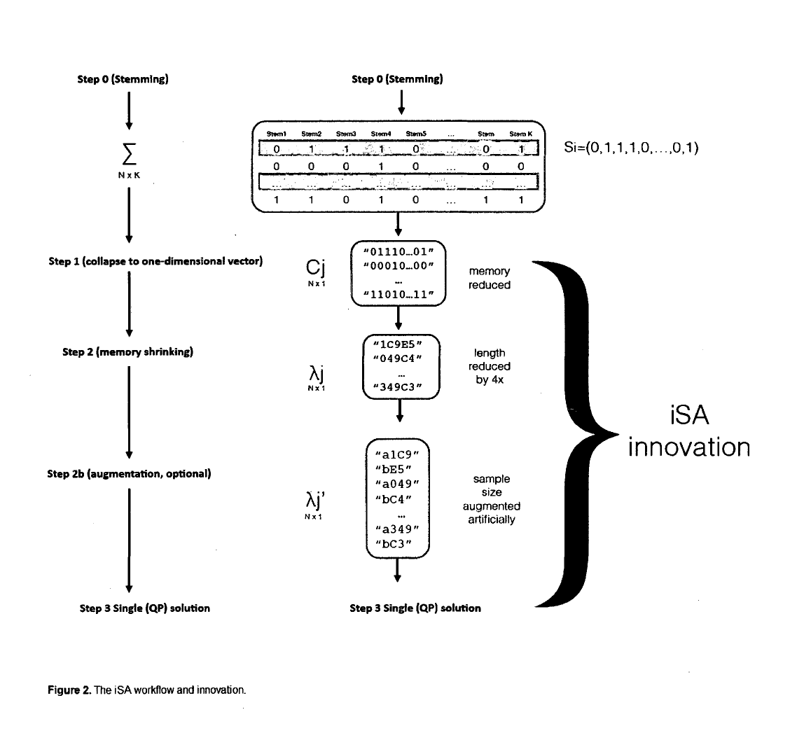

We reserve the symbol D₀ to the texts corresponding to Off-topic or texts which express opinions not relevant with respect to the analysis, i.e. the noise in this framework (see FIG. 1). The noise is commonly present in any corpus of texts crawled from the social network and the Internet in general. For example, in a TV political debate, any non-electoral mention to the candidates or parties are considered as D₀, or any neutral comment or news about some fact, or pure Off-Topic texts like spamming, advertising, etc. The typical workflow of iSA follows few basic steps hereafter described (see FIG. 2).

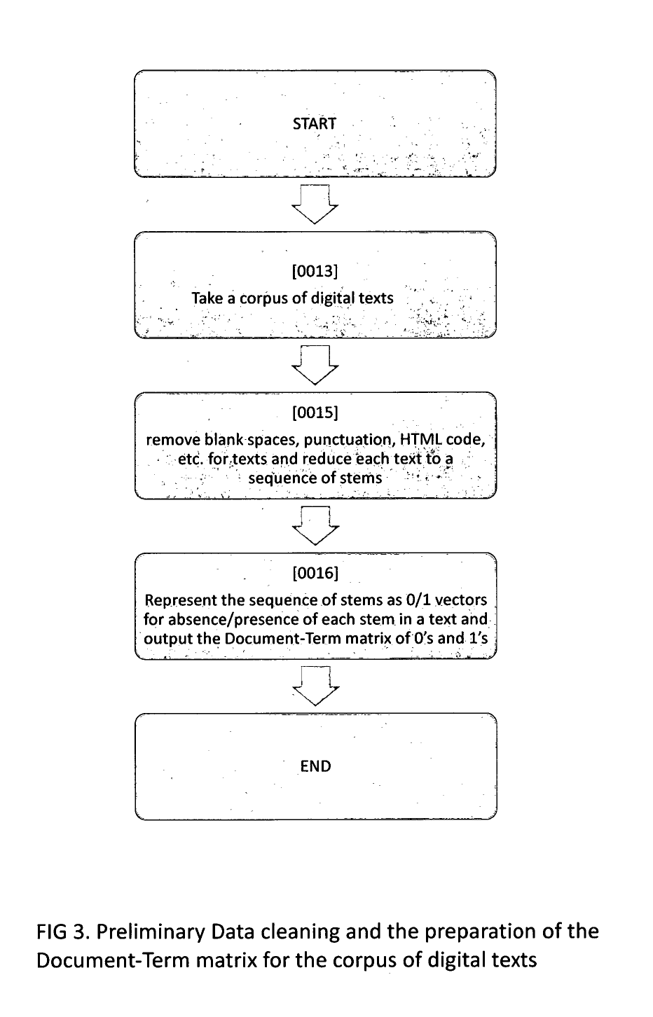

The stemming step (1000). Once the corpus of text is available, a preprocessing step called stemming, is applied to the data. Stemming corresponds to the reduction of texts into a matrix of L stems: words, unigrams, bigrams, etc. Stop words, punctuation, white spaces, HTML code, etc., are also removed. The matrix has N rows and L columns (see FIG. 3).

Let Sᵢ, i=1, . . . , K, be a unique vector of zeros and ones representing the presence/absence of the L possible stems. Notice that more than one text in the corpus can be represented by the same unique vector of stems Sᵢ. The vector Sᵢ belongs to S={0,1}^{L}, the space of 0/1 vectors of length L, where each element of the vector Sᵢ is either 1 if that stem is contained in a text, or 0 in case of absence. Thus, theoretically K=2^{L}.

Let sⱼ, j=1,2, . . . , N be the vector of stems associated to the individual text j in the corpus of N texts, so that sⱼ can be one and only one of the possible Sᵢ. As the space S is, potentially, an incredibly large set (e.g. if L=10, 2^{L}=1024 but is L=100 then 2^{L} is of order 10³⁰), we denote by S̅ the subset of S which is actually observed in a given corpus of texts and we set K̅ equal to the cardinality of S̅. To summarize, the relations of the different dimensions are as follows M<<L<K̅<N, where “<<” means “much smaller”. In practice, M is usually in the order of 10 or less distinct categories, L is in the order of hundreds, K̅ in the order of thousands and N can be up to millions.

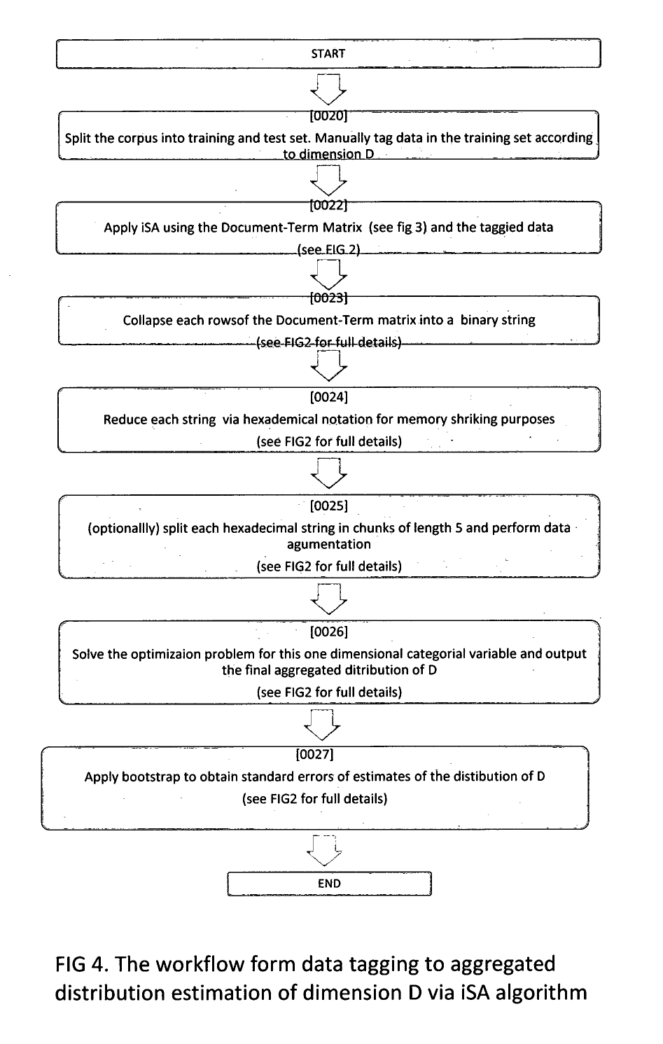

The tagging step. In supervised sentiment analysis, part of the texts in the corpus, called the training set, is tagged (manually or according to some prescribed tool) as dⱼ∈D. We assume that the subset of tagged texts is of size n<<N and that there is no misspecification at this stage. The remaining set of texts of size N-n, for which dⱼ=NA, is called the test set. The whole data set is thus formalized as {(sj, dj), j=1, . . . , N} where sⱼ∈S̅ and dⱼ can either be “NA” (not available or missing) for the test set, or one of the tagged categories D∈D, for the training set. Finally, we denote by Σ=[sⱼ, j∈N] the N×K̅ matrix of stem vectors of the whole corpus. This matrix is fully observed while dⱼ is different from “NA” only for the training set (see FIG. 4).

The classification (or prediction) step. The typical aim of the analysis is the estimation of aggregated distribution of opinions {P(D),D∈D}. Methods other than iSA and ReadMe usually apply individual classification of each single text in the corpus, i.e. they try to predict \hat{d}ⱼ from the observed sⱼ, and then tabulate the distribution of \hat{d}ⱼ to obtain an estimate of P(D), the complete distribution of the opinions contained in the N texts.

At this step, the training set is used build a classification model (or classifier) to predict [symbol] from sⱼ, j=1, . . . , N. We denote this model as P(D|S). The final distribution is obtained from this formula: P(D)=P(D|S)P(S), where P (D) is a M×1 vector, P(D|S) is a M×K̅ matrix of conditional probabilities and P(S) is a K̅×1 vector which represents the distribution of sᵢ over the corpus of texts. As FIG. 1 shows this probability is very hard to estimate and imprecise in the presence of noise, i.e. when D₀, is highly dominant in the data. Thus it is preferable (see, Hookins and King, 2010) to use this representation: P(S)=P(S|D)P(D) which needs the estimation of P(S|D) is a K̅×M matrix of conditional probabilities whose elements P(S=S_{K}|D=Dᵢ) represent the frequency of a particular stem S_{K} given the set of texts which actually express the opinion D=Dᵢ. FIG. 1 shows that this task is statistically reasonable.

At this point is important to remark that iSA does not assume any NLP (Natural Language Processing) rule, i.e. only stemming is applied to texts, therefore the grammar, the order and the frequency of words is not taken into account. iSA works in the “bag of words” framework so the order in which the stems appear in a text is not relevant to the algorithm.

The innovation of iSA algorithm. The new algorithm which we are going to present and called iSA is a fast, memory efficient, scalable and accurate implementation of the above program. This algorithm does not require resampling method and uses the complete length of stems at once by dimensionality reduction. The algorithm proceeds as follows (see FIG. 2):

Step 1: collapse to one-dimensional vector (1002). Each vector of stems, e.g. sⱼ=(0, 1, 1, 0, . . . , 0, 1) is transformed into a string-sequence Cⱼ=“0110 . . . 01”; this is the first level of dimensionality reduction of the problem: from a matrix Σ of dimension N×K̅ into a one-dimensional vector of length N×1.

Step 2: memory shirking (1004): this sequence of 0's and 1's is further translated into hexadecimal notation such that the sequence ‘11110010’ is recoded as λ=‘F2’ or ‘11100101101’ as λ=‘F2D’, and so forth. So each text is actually represented by a single hexadecimal label λ of relatively short length. Eventually, this can be further recorded as long-integers into the memory of a computer for memory efficiency but when Step 3 [0022] below is recommended, the string format should be kept. Notice that, the label Cⱼ representing the sequence sⱼ of, say, a hundred of 0's and 1's can be stored in just 25 characters into λ, i.e. the length is reduced to one fourth of the original one due to the hexadecimal notation.

Step 2b: augmentation, optional (1006). In the case of non-random or sequential tagging of the training set, it is recommended to split the long sequence and artificially augment the size of the problem as follows. The sequence λ of hexadecimal codes is split into subsequences of length 5, which corresponds to 20 stems in the original 0/1 representation (other lengths can be chosen, this does not affect the algorithm but at most the accuracy of the estimates). For example, suppose to have the sequence λⱼ=‘F2A10DEFF1AB4521A2’ of 18 hexadecimal symbols and the tagged category dⱼ=D₃. The sequence λⱼ is split into 4=┌18/5┐ chunks of length five or less: λⱼ¹=‘aFEA10’, λⱼ²=‘bDEFF1’, λⱼ³=‘cAB452’ and λⱼ⁴=‘d1A2’. At the same time, the dⱼ are replicated (in this example) four times, i.e. d₁¹=D₃, dⱼ²=D₃, dⱼ³=D₃ and dⱼ⁴=D₃. The same applies to all sequences of the training set and those in the test set. This method results into a new data set of length which is four times the original length of the data set, i.e. 4N. When Step 2b is used, we denote iSA as iSAX (where “X” stands for sample size augmentation) to simplify the exposition.

Step 3: QP step (1008). Whether or not Step 2b have been applied, the original problem P(D)=P(D|S)P(S) is transformed into a new one: P(D)=P(D|λ)P(λ), and hence we can introduce the equation: P(λ)=P(λ|D)P(D). Thus, finally Step 3 solves next optimization problem exactly with a single Quadratic Programmaing step: P(D)=[P(λ|D)^{T}P(λ|D)] P⁻¹(λ|D) P^{T}(λ).

Step 4 (bootstrap, optional). In order to obtain standard errors of the point estimates for P(D), the rows of the original matrix Σ can be resampled according to the standard bootstrap approach and Steps 1 to 3 replicated. Averaging over the estimates and the empirical standard deviation can be used.

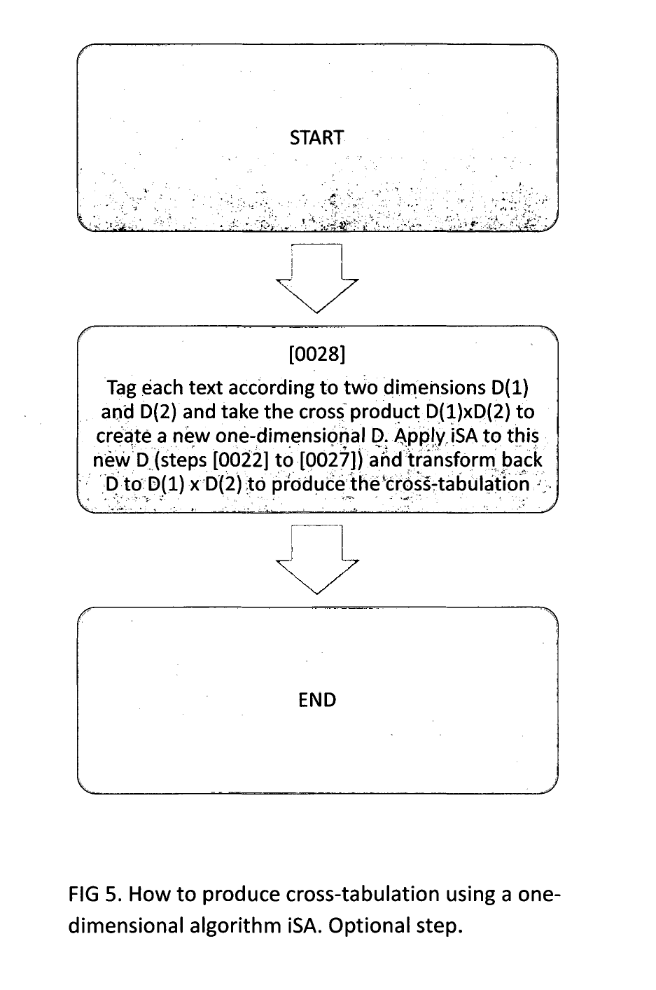

The ability of iSA to work even when the sample size of the training set is very small can be exploited to run a cross-tabulation of categorization when a corpora of texts is tagged along multiple dimensions. Suppose to have a training set where D⁽¹⁾ is the tagging for the first dimension on M⁽¹⁾ possible values and D⁽²⁾ is the tagging for the second dimension on M⁽²⁾ possible values, M⁽¹⁾ not necessarily the same as M⁽²⁾. We can consider the cross-product of the values D⁽¹⁾×D⁽²⁾=D so that D will have M=M⁽¹⁾·M⁽²⁾ possible distinct values, not all of them available in the corpus. We can now apply iSA Step 1 to Step4 to this new tag variable D, and estimate P(D). Once the estimates of P(D) are available, we can reconstruct the bivariate distribution ex-post. In general this approach is not feasible for typical machine learning methods as the number of categories to estimate increases quadratically and the estimates of P(D|S) become even more unstable. To show this capability we show an application in the next section (FIG. 5).

### EXAMPLES

To describe the performance of iSA, we compare it with ReadMe, as it is the only other method of aggregated distribution estimation in sentiment analysis. We use the version available in the R package ReadMe (Hopkins, D., King, G., 2013. ReadMe: Software for Automated Content Analysis. R package version 0.99836. URL http://gking.harvard.edu/readme). In order to evaluate the performance of each classifier, we estimate \hat{P}(D) for all texts (in the training and test sets) using iSA/iSAX and ReadMe. As stated before, in the tables below we denote by iSAX the version of iSA when augmentation Step 2b [0022] is used.

We compare the estimated distribution using MAE (mean absolute error), i.e.

$$M A E ( method ) = \frac{1}{M} {\sum }_{i = 0}^{M} \vert {\hat{P}}_{method} ( {D}_{i} ) - P ( {D}_{i} ) \vert$$

and the χ² Chi-squared test statistic

$${χ}^{2} ( method ) = \frac{1}{M} {\sum }_{i = 0}^{M} \frac{{( {\hat{P}}_{method} ( {D}_{i} ) - P ( {D}_{i} ) )}^{2}}{P ( {D}_{i} )}$$

where the “method” is one among iSA/iSAX and ReadMe. We run each experiment 100 times (A larger number of simulations is unfeasible in most cases given the unrealistic computational times of the methods other than iSA). All computations have been performed on a Mac Book Pro, 2.7 GHz with Intel Core i7 processor and 16 GB of RAM. All times for iSA include 100 bootstrapping replications for the standard error of the estimates even if these estimates are not shown in the Monte Carlo analysis.

For the analysis we use Martin Porter's stemming algorithm and the libstemmer library from http://snowball.tartarus.org as implemented in the R package SnowballC (Bouchet-Valat, M., 2014. SnowballC: Snowball stemmers based on the C libstemmer UTF-8 library. R package version 0.5.1. URL http://CRAN.R-project.org/package=SnowballC). After stemming, we drop the stems whose sparsity index is greater than the q % threshold, i.e. stem which appear less frequently than q % in the whole corpus of texts. Stop words, punctuation and white spaces are stripped as well from the texts. Thus all methods works on the same starting matrix of stems.

Empirical results with random sampling. We run a simulation experiment taking into account only the original training set of n observations. The experiment is designed as follows: we randomly partition the n observations into two portions: p·n observations will constitute a new training set and (1-p)·n observations are considered as test set, i.e. the true category is disregarded. We let p vary in 0.25, 0.5, 0.75 and 0.9.

We consider the so called “Large Movie Review Dataset” (Maas, A. L., Daly, R. E., Pham, P. T., Huang, D., Ng, A. Y., Potts, C., June 2011. Learning word vectors for sentiment analysis. In: Proceedings of the 49th Annual Meeting of the Association for Computational Linguistics: Human Language Technologies. Association for Computational Linguistics, Portland, Oreg., USA, pp. 142-150. URL http://www.aclweb.org/anthology/P11-1015) originally designed for a different task. This data set consists of 50000 reviews from IMDb, the Internet Movie Database (http://www.imdb.com) manually tagged as positive and negative reviews but also including the number of “stars” assigned by the internet users to each review. Half of these reviews are negative and half are positive. Our target D consists in the stars assigned to each review, a much difficult task than the dichotomous classification into positive and negative. The true target distribution of stars P(D) is given in Table 1. Categories “5” and “6” do not exist in the original data base. We have M=8 for this data set. The original data can be downloaded at http://ai.stanford.edu/-amaas/data/sentiment/.

For the simulation experiment we confine the attention to the 25000 observations in the original training set. Notice that in this data set there is no miss-specification or Off-Topic category, so we should expect that traditional method to perform well.

TABLE 1

| Number of stars D | 1 | 2 | 3 | 4 | 7 | 8 | 9 | 10 | Total |
|---|---|---|---|---|---|---|---|---|---|
| target P(D) | 20.4 | 9.1 | 9.7 | 10.8 | 10.7 | 12.0 | 9.1 | 18.9 | 100 |
| n. hand coded | 5100 | 2284 | 2420 | 2696 | 2496 | 3009 | 2263 | 4732 | n = 25000 |
| texts | | | | | | | | | |
| target P(D) | 18.9 | 9.9 | 9.3 | 11.2 | 9.8 | 12.5 | 8.9 | 19.5 | 100 |
| n. hand coded | 355 | 186 | 174 | 210 | 184 | 234 | 166 | 366 | n = 2500 |
| texts | | | | | | | | | |

Legend: (Top) True distribution of P(D) for the Large Movie Review dataset. Fully hand coded training set sample size n = 25000. (Bottom) The distribution P(D) of the random sample of n = 2500 texts used in the simulation studies of Table 2.

As can be seen from Table 1, the reviews are polarized and the true distribution of P(D) is unbalanced: D₁ and D₁₀ amount to the 40% of the total probability mass distribution, the remaining being essentially equidistributed.

After elementary stemming and removing stems with sparsity index of 0.95, the remaining stems are L=320. To reduce the computational times, we considered a random sample of size 2500 observations from the original training set of 25000. The results of the analysis are collected in Table 2. In this example, iSA/iSAX out-performs ReadMe for all sample sizes in terms of MAE and χ². iSA, but not ReadMe, behaves as expected as the sample size increases, i.e., the MAE and χ² decrease, as well as the Monte Carlo standard deviation of the MAE estimate, in parentheses. The fact that ReadMe does not perform like iSA might be due to the fact that, increasing the sample size of the training set the number of stems on which ReadMe has to perform bagging increases as well; in some cases, the algorithm does not provide stable results as the number of re-sampled stems is not sufficient and therefore, an increased number of bagging replications will be necessary (in our simulations we kept all tuning parameters fixed and we changed the sample size only). Computational times remain essentially stable and around fraction of seconds for iSA/iSAX and half minute for ReadMe. For all p's the iSA/iSAX algorithm is faster, more stable and accurate than ReadMe.

TABLE 2

| Method | ReadMe | iSA | iSAX |
|---|---|---|---|
| p = 25% (n = 625) | 0.040 | 0.010 | 0.014 |
| MAE | | | |
| MC Std. Dev. | [0.005] | [0.003] | [0.004] |
| χ² | 0.087 | 0.005 | 0.009 |
| speed | (15.6x) | (0.2x) | (1 = 0.3 s) |
| p = 50% (n = 1250) | 0.039 | 0.006 | 0.009 |
| MAE | | | |
| MC Std. Dev. | [0.004] | [0.002] | [0.003] |
| χ² | 0.085 | 0.002 | 0.004 |
| speed | (14.7x) | (0.2x) | (1 = 0.3 s) |
| p = 75% (n = 1875) | 0.039 | 0.003 | 0.006 |
| MAE | | | |
| MC Std. Dev. | [0.004] | [0.001] | [0.002] |
| χ² | 0.080 | 0.001 | 0.002 |
| speed | (14.3x) | (0.2x) | (1 = 0.3 s) |
| p = 90% (n = 2250) | 0.039 | 0.002 | 0.004 |
| MAE | | | |
| MC Std. Dev. | [0.007] | [0.001] | [0.001] |
| χ² | 0.081 | 0.000 | 0.001 |
| speed | (14.1x) | (0.2x) | (1 = 0.3 s) |

Legend:
Monte Carlo results for the Large Movie Review dataset. Table contains MAE, Monte Carlo standard errors of MAE estimates, χ² statistic, and execution times for each individual replication in seconds as multiple of the base line which is iSAX. Sample size N = 2500 observations from the original Large Movie Review training set. Number of stems 320, threshold 95%. For the iSAX method we report, in parentheses, the number of seconds per each single iteration in the analysis, which means, the total time of the simulation must be multiplied by a factor of 100.

Classification on the complete data set. Given that this data set is completely hand coded we can use all the 25000 observations in the original training set and the 25000 observations of the test set, we can run the classifiers and compare with the true distribution with the corresponding estimates. For this we disregard the hand coding of the 25000 observations in the test set. The results, given in Table 3, show that iSA/iSAX is again the more accurate than ReadMe in terms of MAE and χ². Nevertheless, for each iteration iSA took only 2.6 seconds with bootstrap (5.7 seconds for iSAX) and the ReadMe algorithm required 105 s.

TABLE 3

| n = 25000 | ReadMe | iSA | iSAX |
|---|---|---|---|
| MAE | 0.044 | 0.002 | 0.014 |
| χ² | 0.120 | 0.000 | 0.010 |
| Time | 105 s | 2.6 s | 5.7 s |

Legend:
Classification results on the complete Large Movie Review Database. The table contains the estimated distribution of P (D) for each method, the relative MAE and the computational times in seconds, relative to the classification of the set of 50000 observations from the Large Movie Review Database where 25000 observations are used as training set. Number of stems 309, threshold 95%.

Empirical results: Sequential sampling. In this experiment we create a random sample which contains the same number of entries per category D. This is to mimic the case of sequential random sampling, although only approximately as this sample is still random. This type of sampling approximates the case where the distribution of P(D) in training set is quite different to the target distribution. We let the number of observations in the training set for each category D to vary in the set {10, 25, 50, 10, 300}. In real applications, most of the times the number of hand coded text is not less than 20. Looking at the results in Table 4 one can see that iSA and iSAX are equivalent and slightly better than ReadMe.

TABLE 4

| method | ReadMe | iSA | iSAX |
|---|---|---|---|
| n = 10M = 80 (1.6%) | 0.038 | 0.036 | 0.035 |
| MAE | | | |
| MC Std. Dev. | [0.004] | [0.001] | [0.005] |
| χ² | 0.058 | 0.050 | 0.051 |
| speed | (14.8x) | (0.2x) | (1 = 0.7 s) |
| n = 25M = 200 (4.0%) | 0.037 | 0.036 | 0.034 |
| MAE | | | |
| MC Std. Dev. | [0.002] | [0.001] | [0.005] |
| χ² | 0.054 | 0.050 | 0.049 |
| speed | (15.5x) | (0.2x) | (1 = 0.7 s) |
| n = 50M = 400 (8.0%) | 0.036 | 0.036 | 0.034 |
| MAE | | | |
| MC Std. Dev. | [0.002] | [0.001] | [0.005] |
| χ² | 0.051 | 0.050 | 0.047 |
| speed | (15.4x) | (0.2x) | (1 = 0.3 s) |
| n = 100M = 800 (16.0%) | 0.035 | 0.036 | 0.030 |
| MAE | | | |
| MC Std. Dev. | [0.002] | [0.000] | [0.005] |
| χ² | 0.050 | 0.050 | 0.039 |
| speed | (14.7x) | (0.2x) | (1 = 0.7 s) |
| n = 300M = 2400 (48.0%) | 0.033 | 0.036 | 0.028 |
| MAE | | | |
| MC Std. Dev. | [0.003] | [0.000] | [0.003] |
| χ² | 0.050 | 0.050 | 0.033 |
| speed | (14.2x) | (0.2x) | (1 = 0.7 s) |

Legend:
Monte Carlo results for the Large Movie Review Database. Table contains MAE, Monte Carlo standard errors of MAE estimates, χ² test statistic, and execution times for each individual replication in seconds as multiple of the base line which is iSAK. Training set is made by sampling n hand-coded texts per each of the M = 8 categories D to break proportionality. Total number of observations N = 5000 sampled from the original Large Movie Review data set. Number of stems 310, threshold 95%.

We tried also to use a very small sample size to predict the whole 50000 original entries in the Movie Review Database and compare it with the case of a training set of size 25000. Table 5 shows that iSA/iSAX is very powerful in both situations and dominate ReadMe in terms of MAE and χ². In addition, for ReadMe, the timing also depends on the number of category D and the number of items coded per category.

TABLE 5

| | ReadMe | iSA | iSAX |
|---|---|---|---|
| n = 25000 | | | |
| MAE | 0.044 | 0.002 | 0.014 |
| χ² | 0.120 | 0.000 | 0.010 |
| Time | 105 s | 17.2 s | 41.8 s |
| n = 80 | | | |
| MAE | 0.037 | 0.036 | 0.029 |
| χ² | 0.059 | 0.050 | 0.038 |
| Time | 114.5 s | 15.6 s | 40.5 s |

Legend:
Classification results on the complete Large Movie Review Database. The table contains the estimated distribution of P (D) for each method, the relative MAE and the computational times in seconds, relative to the classification of the set of 50000 observations from the Large Movie Review Database where 25000 observations are used as training set (Top) and (Bottom) where only 10 observations per category have been chosen for the training set (sample size: training set = 80, test set = 49840). A total of 1000 bootstrap replications for the evaluation of the standard errors of iSA and iSAX estimates. Number of stems 309, threshold 95%.

Confidence intervals and point estimates. We finally evaluate 95% confidence intervals for iSA/iSAX in both cases in Table 6. ReadMe require further bootstrap analysis in order to produce standard errors which make the experiment unfeasible so we didn't consider standard errors for this method. From Table 6 we can see that in most cases, iSA/iSAX confidence intervals contain the true values of the parameters. The only cases in which true value is outside the lower bound of the confidence interval for iSA (but correctly included in those of iSAX) are the categories D₇ and D₈.

TABLE 6

| Stars | | True | | iSAX | | ReadMe | | iSA | |
|---|---|---|---|---|---|---|---|---|---|
| 1 | | 0.202 | | 0.200 | | 0.201 | | 0.204 | |
| 2 | | 0.092 | | 0.093 | | 0.241 | | 0.091 | |
| 3 | | 0.099 | | 0.101 | | 0.111 | | 0.097 | |
| 4 | | 0.107 | | 0.105 | | 0.099 | | 0.108 | |
| 7 | | 0.096 | | 0.086 | | 0.098 | | 0.100 | |
| 8 | | 0.117 | | 0.111 | | 0.076 | | 0.121 | |
| 9 | | 0.092 | | 0.085 | | 0.094 | | 0.090 | |
| 10 | | 0.195 | | 0.195 | | 0.080 | | 0.189 | |
| MAE | | | | 0.007 | | 0.040 | | 0.002 | |
| χ² | | | | 0.002 | | 0.116 | | 0.000 | |
| Stars | Lower | True | iSA | Upper | Stars | Lower | True | iSAX | Upper |
| 1 | 0.202 | 0.202 | 0.204 | 0.206 | 1 | 0.188 | 0.202 | 0.200 | 0.213 |
| 2 | 0.090 | 0.092 | 0.091 | 0.093 | 2 | 0.083 | 0.092 | 0.093 | 0.103 |
| 3 | 0.096 | 0.099 | 0.097 | 0.099 | 3 | 0.088 | 0.099 | 0.101 | 0.114 |
| 4 | 0.106 | 0.107 | 0.108 | 0.109 | 4 | 0.092 | 0.107 | 0.105 | 0.118 |
| 7 | 0.098 | 0.096 | 0.100 | 0.102 | 7 | 0.076 | 0.096 | 0.086 | 0.096 |
| 8 | 0.119 | 0.117 | 0.121 | 0.122 | 8 | 0.100 | 0.117 | 0.111 | 0.122 |
| 9 | 0.089 | 0.092 | 0.090 | 0.092 | 9 | 0.077 | 0.092 | 0.085 | 0.093 |
| 10 | 0.187 | 0.195 | 0.189 | 0.191 | 10 | 0.210 | 0.195 | 0.218 | 0.226 |

Legend: Classification results on the complete Large Movie Review Database. Data as in Table 5 for the whole data set of 50000 observations with n = 25000. Up: the final estimated distributions, Bottom: the 95% confidence interval upper-bound and lower-bound estimates for iSA and iSAX.

Application to cross-tabulation. In order to show the ability of iSA to produce cross-tabulation statistics we use a different dataset. This data set consists of a corpus of N=39845 text about the Italian Prime Minister Renzi, collected on Twitter from Apr. 20to May 22, 2015, with a hand-coded training set of n=1324 texts. Text have been tagged according to the discussions about Prime Minister's political action D⁽¹⁾ (from “Environment” to “School”, M⁽¹⁾=10 including Off-Topic) and according to the sentiment D⁽²⁾ (Negative, Neutral, Positive and Off-Topic, M⁽²⁾=4) as shown in Table 7. The new variable D consists of M=25 distinct and non-empty categories.

Table 8 show the performance of iSAX on the whole corpus based on the training set of the above 1324 hand-coded texts. The middle and bottom panel, also show the conditional distributions which are very useful in the interpretation of the analysis: for instance, thanks to the cross-tabulation, looking at the conditional distribution D⁽²⁾|D⁽¹⁾, we can observe that when people talks about the “Environmental” issue Renzi attracts a relatively higher share of positive sentiment. Conversely, the positive sentiment toward the Prime Minister is lower within conversations related to, e.g., the state of the economy, as well as in those concerning labor policy and the school reform. Similar considerations applies to the conditional distribution D⁽¹⁾|D⁽²⁾.

TABLE 7

| | C01 | | C02 | | C03 | | C04 Off- | | | |
|---|---|---|---|---|---|---|---|---|---|---|
| D⁽¹⁾ × D⁽²⁾ | Negative | | Neutral | | Positive | | Topic | | Total | |
| R01: Environment | 10 | | | | 45 | | | | 55 | |
| R02: Electoral campaign | 60 | | 3 | | 4 | | | | 67 | |
| R03: Economy | 80 | | 2 | | 5 | | | | 87 | |
| R04: Europe | 11 | | | | | | | | 11 | |
| R05: Law & Justice | 54 | | 3 | | 30 | | | | 87 | |
| R06: Immigration & Homeland | 48 | | 4 | | 6 | | | | 58 | |
| security | | | | | | | | | | |
| R07: Labor | 23 | | 1 | | 4 | | | | 28 | |
| R08: Electoral Reform | 46 | | 5 | | 5 | | | | 56 | |
| R09: School | 445 | | 46 | | 79 | | | | 570 | |
| R10: Off-Topic | | | | | | | 305 | | 305 | |
| Total | 777 | | 64 | | 178 | | 305 | | 1324 | |
| | R01- | R01- | R02- | R02- | R02- | R03- | R03- | R03- | R04- | R05- |
| D | C01 | C03 | C01 | C02 | C03 | C01 | C02 | C03 | C01 | C01 |
| count | 10 | 45 | 60 | 3 | 4 | 80 | 2 | 5 | 11 | 54 |
| | R05- | R05- | R06- | R06- | R06- | R07- | R07- | R07- | R08- | R08- |
| D | C02 | C03 | C01 | C02 | C03 | C01 | C02 | C03 | C01 | C02 |
| count | 3 | 30 | 48 | 4 | 6 | 23 | 1 | 4 | 46 | 5 |

| | R08- | R09- | R09- | R09- | R10- | |
|---|---|---|---|---|---|---|
| D | C03 | C01 | C02 | C3 | C03 | Total |
| count | 5 | 445 | 46 | 79 | 305 | 1324 |

Legend: The Renzi data set. Table contains the two-ways table D⁽¹⁾ against D⁽²⁾ (Up) and the recoded distribution D = D⁽¹⁾ × D⁽²⁾ (Bottom) that is used to run the analysis. Training set consists of n = 1324 hand-coded texts. Total number of texts in the corpus N = 39845. Number of stems 216, threshold 95%.

TABLE 8

| | Negative | Neutral | Positive | Off-Topic | Total |
|---|---|---|---|---|---|
| Joint distribution | | | | | |
| D⁽²⁾ × D⁽¹⁾ | | | | | |
| Environment | 1.54% | | 2.07% | | 3.61% |
| Electoral | 6.06% | 0.64% | 0.79% | | 7.48% |
| campaign | | | | | |
| Economy | 6.70% | 0.37% | 1.15% | | 8.23% |
| Europe | 1.35% | | | | 1.35% |
| Law & Justice | 6.35% | 0.67% | 2.20% | | 9.22% |
| Immigration & | 6.82% | 1.19% | 1.03% | | 9.05% |
| Homeland | | | | | |
| security | | | | | |
| Labor | 1.75% | 0.13% | 1.03% | | 2.91% |
| Electoral Reform | 3.31% | 1.11% | 0.95% | | 5.37% |
| School | 19.42% | 1.13% | 3.54% | | 24.08% |
| Off-Topic | | | | 28.70% | 28.70% |
| Total | 53.30% | 5.24% | 12.76% | 28.70% | 100% |
| Conditional | | | | | |
| distribution | | | | | |
| D⁽²⁾\|D⁽¹⁾ | | | | | |
| Environment | 42.65% | | 57.35% | | 100.00% |
| Electoral | 80.96% | 8.52% | 10.52% | | 100.00% |
| campaign | | | | | |
| Economy | 81.48% | 4.49% | 14.03% | | 100.00% |
| Europe | 100.00% | | | | 100.00% |
| Law & Justice | 68.83% | 7.29% | 23.89% | | 100.00% |
| Immigration & | 75.43% | 13.17% | 11.40% | | 100.00% |
| Homeland | | | | | |
| security | | | | | |
| Labor | 60.10% | 4.60% | 35.30% | | 100.00% |
| Electoral Reform | 61.66% | 20.68% | 17.66% | | 100.00% |
| School | 80.62% | 4.68% | 14.70% | | 100.00% |
| Off-Topic | | | | 100.00% | 100.00% |

| Conditional distribution | | | | |
|---|---|---|---|---|
| D⁽¹⁾\|D⁽²⁾ | Negative | Neutral | Positive | Off-Topic |
| Environment | 2.88% | | 16.20% | |
| Electoral campaign | 11.37% | 12.16% | 6.17% | |
| Economy | 12.58% | 7.05% | 9.05% | |
| Europe | 2.54% | | | |
| Law & Justice | 11.91% | 12.82% | 17.26% | |
| Immigration & | 12.80% | 22.73% | 8.08% | |
| Homeland security | | | | |
| Labor | 3.29% | 2.55% | 8.06% | |
| Electoral Reform | 6.21% | 21.17% | 7.43% | |
| School | 36.43% | 21.51% | 27.74% | |
| Off-Topic | | | | 100.00% |
| Total | 100.00% | 100.00% | 100.00% | 100.00% |

Legend:
The Renzi data set. Estimated joint distribution of D⁽¹⁾ against D⁽²⁾ (Top), conditional distribution of D⁽²⁾|D⁽¹⁾ (Middle) and conditional distribution of D⁽¹⁾|D⁽²⁾ (Bottom) using iSAX. Training set as in Table 7.

### REFERENCES

Bouchet-Valat, M., 2014. SnowballC: Snowball stemmers based on the C libstemmer UTF-8 library. R package version 0.5.1. URL http://CRAN.R-project.org/package=SnowballC
Breiman, L., 2001. Random forests. Machine Learning 45 (1), 5-32.
Cambria, E., Schuller, B., Xia, Y., Havasi, C., 2013. New avenues in opinion mining and sentiment analysis. IEEE Intelligent Systems 28 (2), 15-21.
Canova, L., Curini, L., Iacus, S., 2014. Measuring idiosyncratic happiness through the analysis of twitter: an application to the italian case. New Media & Society May, 1-16. URL DOI:10.1007/s11205-014-0646-2
Ceron, A., Curini, L., Iacus, S., 2013a. Social Media e Sentiment Analysis. L'evoluzione dei fenomeni sociali attraverso la Rete. Springer, Milan.
Ceron, A., Curini, L., Iacus, S., 2015. Using sentiment analysis to monitor electoral campaigns. method matters. evidence from the united states and Italy. Social Science Computer Review 33 (1), 3-20. URL DOI:10.1177/0894439314521983
Ceron, A., Curini, L., Iacus, S., Porro, G., 2013b. Every tweet counts? how sentiment analysis of social media can improve our knowledge of citizens political preferences with an application to italy and france. New Media & Society 16 (2), 340-358. URL DOI:10.1177/1461444813480466
Hopkins, D., King, G., 2010. A method of automated nonparametric content analysis for social science. American Journal of Political Science 54 (1), 229-247.
Hopkins, D., King, G., 2013. ReadMe: ReadMe: Software for Automated Content Analysis. R package version 0.99836. URL http://gking.harvard.edu/readme
Iacus, H. M., 2014. Big data or big fail? the good, the bad and the ugly and the missing role of statistics. Electronic Journal of Applied Statistical Analysis 5 (11), 4-11.
Kalampokis, E., Tambouris, E., Tarabanis, K., 2013. Understanding the pre-dictive power of social media. Internet Research 23 (5), 544-559.
King, G., 2014. Restructuring the social sciences: Reflections from harvard's institute for quantitative social science. Politics and Political Science 47 (1), 165-172.
Maas, A. L., Daly, R. E., Pham, P. T., Huang, D., Ng, A. Y., Potts, C., June 2011. Learning word vectors for sentiment analysis. In: Proceedings of the 49th Annual Meeting of the Association for Computational Linguistics: Human Language Technologies. Association for Computational Linguistics, Portland, Oreg., USA, pp. 142-150 . URL http://www.aclweb.org/anthology/P11-1015
Meyer, D., Dimitriadou, E., Hornik, K., Weingessel, A., Leisch, F., 2014. e1071: Misc Functions of the Department of Statistics (e1071), TU Wien. R package version 1.6-3. URL http://CRAN.R-project.org/package=e1071
Schoen, H., Gayo-Avello, D., Metaxas, P., Mustafaraj, E., Strohmaier, M., Gloor, P., 2013. The power of prediction with social media. Internet Re-search 23 (5), 528-543.

1. A method comprising:
a) receiving a set of individually single-labeled texts according to a plurality of categories;
b) estimating the aggregated distribution of the same categories in a) for another set of uncategorized texts without individual categorization of texts.;

2. The method of claim 1, wherein b) comprises the construction of a Term-Document matrix consisting of one row per text and a sequence of zeroes and ones to signal presence absence of each term for both labeled and unlabeled sets.

3. The method of claim 1, wherein b) comprises the construction of a vector of labels of the same length of the row of the TermDocument matrix which contain the true categories for the labeled set of texts in claim 1 a) and an empty string for the unlabeled set of texts in claim 1 b).

4. The method of claim 1, wherein b) comprises the collapsing of each sequence of zeros and ones into a string producing a memory shrinking collapsing the TermDocument matrix in claim 3 into a one-dimensional string vector of features.

5. The method of claim 1, wherein b) comprises further transform of the elements of the vector of features into hexadecimal strings reducing by a factor of four the length of the strings elements in the vector of features in claim 4.

6. The method of claim 1, wherein b) comprises the splitting of hexadecimal strings into subsequences of a given length resulting in augmentation of the length of the vector of features in claim 5.

7. The method of claim 1, wherein b) comprises the argumentation of the vector of labels in parallel with the argumentation of the vector for features of claim 7.

8. The method of claim 1, wherein b) comprises the use of quadratic programming to solve a constrained optimization problem which receives as input the argumented vector of features in claim 6 and the argumented vector of labels from claim 7 and produces as output an approximately unbiased estimation of the distribution of categories for the sets of texts in claim 1 a) and b).

9. The method of claim 1, wherein b) comprises the use of standard bootstrap approach (resampling of the rows of the TermDocument matrix) and execute claims 1 to 8 and then averages the estimates of the distribution of categories along the number of replications to produce unbiased estimated of the standard errors.

10. A method comprising:
a) receiving a set of individually double-labeled (label1 and label2) texts according to a plurality of categories;
b) estimating the cross-tabulation of the aggregated distribution of the same categories in a) for another set of uncategorized texts without individual categorization of texts.

11. The method of claim 10, wherein b) comprises the construction of a new set of labels (label0) which is the product of all possible categories of label1 and label2.

12. The method of claim 10, wherein b) comprises the estimation of the distribution of the categories of label0 in claim 11 for the unlabeled sets of claim 10 b).

13. The method of claim 10, wherein b) comprises the application of claims 1 to 9 for the estimation of the distribution of label0 in claim 11.

14. The method of claim 10, wherein b) comprises reverse split of estimation of the distribution of label0 estimated in claim 13, into the original label1 and label2.
